(19) United States
(12) Patent Application Publication
(10) Pub. No.: US 2026/0236805 A1
(43) Pub. Date: Aug. 13, 2026

(54) DATA ANALYZING DEVICE, INFORMATION PROCESSING SYSTEM, AND DATA ANALYZING METHOD

(71) Applicant: Mitsubishi Electric Corporation, Tokyo (JP)

(72) Inventor: Yoshihiro MITSUKA, Tokyo (JP)

(73) Assignee: Mitsubishi Electric Corporation, Tokyo (JP)

(21) Appl. No.: 19/636,215

(22) Filed: Apr. 1, 2026

Related U.S. Application Data
(63) Continuation of application No. PCT/JP2023/042631, filed on Nov. 29, 2023.

(51) Int. Cl. G06N 5/04; G06N 5/01

(52) U.S. Cl. CPC G06N 5/04; G06N 5/01

(57) ABSTRACT

There are included: a task processing unit including a learning processing unit to receive an input of a data set including a plurality of learning tasks each including a plurality of pieces of data and output data indicating an inference model parameter or metadata; and a task searching unit to receive inputs of the data set and data indicating an output result by the task processing unit, and output data indicating a contribution of a learning task included in the data set to the output result or data indicating a learning task of which the contribution is characteristic.

### CROSS REFERENCE TO RELATED APPLICATION

This application is a Continuation of PCT International Application No. PCT/JP2023/042631, filed on Nov. 29, 2023, which is hereby expressly incorporated by reference into the present application.

### TECHNICAL FIELD

The present disclosure relates to a data analyzing device that analyzes data, an information processing system, and a data analyzing method.

### BACKGROUND ART

Patent Literature 1 discloses a method of analyzing a factor of prediction by a learned machine learning model, reconstructing a learning data set, and re-performing learning. In particular, Patent Literature 1 discloses that a search unit performs sensitivity analysis on the influence of a change in learning data on prediction, a confirmation unit presents data having a large degree of influence and requests a determination from a user, and a configuration unit reconfigures data to create data for relearning.

### CITATION LIST

### Patent Literature

Patent Literature 1: JP 2022-131406 A

### SUMMARY OF INVENTION

### Technical Problem

On the other hand, in a case where it is desired to improve reliability of a device using multi-task learning or meta-learning, it is desirable to evaluate reliability in units of tasks.

However, the related art disclosed in Patent Literature 1 is not intended to improve reliability, and even when used for such purpose, evaluation cannot be performed on a task-by-task basis, thereby requiring determination based on the contribution from an individual piece of data.

The present disclosure has been made to solve the above problem, and an object thereof is to provide a data analyzing device capable of analyzing data in units of tasks.

### Solution to Problem

A data analyzing device according to the present disclosure includes: a task processor include a learning processor to receive an input of a data set including a plurality of learning tasks each including a plurality of pieces of data and output data indicating an inference model parameter or metadata; and a task searching processor to receive inputs of the data set and data indicating an output result by the task processor, and output data indicating a contribution of a learning task included in the data set to the output result or data indicating a learning task of which the contribution is characteristic.

### Advantageous Effects of Invention

According to the present disclosure, with the above configuration, data can be analyzed in units of tasks.

### BRIEF DESCRIPTION OF DRAWINGS

FIG. 1 is a block diagram illustrating a configuration example of an information processing system including a data analyzing device according to a first embodiment.

FIG. 2 is a block diagram illustrating a configuration example of the data analyzing device according to the first embodiment.

FIG. 3 is a block diagram illustrating another configuration example of the data analyzing device according to the first embodiment.

FIG. 4 is a block diagram illustrating another configuration example of the data analyzing device according to the first embodiment.

FIG. 5 is a block diagram illustrating another configuration example of the data analyzing device according to the first embodiment.

FIG. 6 is a flowchart illustrating an operation example of the data analyzing device according to the first embodiment.

FIG. 7 is a diagram illustrating an example of a data set and an inference task (test task) used in the data analyzing device according to the first embodiment.

FIG. 8 is a diagram for describing an operation example in a case of multi-task learning of a task processing unit in the first embodiment.

FIG. 9 is a diagram for describing an operation example in a case of meta-learning of the task processing unit in the first embodiment.

FIG. 10 is a diagram for describing an example of calculating a contribution of a learning task to a learning processing result of a task searching unit in the first embodiment.

FIG. 11 is a diagram for describing an example of calculating a contribution of the learning task to an inference processing result of the task searching unit in the first embodiment.

FIG. 12 is a diagram for describing an example of calculating a contribution of the learning task to an additional adjustment processing result of the task searching unit in the first embodiment.

FIG. 13 is a diagram for describing an example of calculating a contribution of the learning task to the inference processing result after additional adjustment processing of the task searching unit is performed in the first embodiment.

FIGS. 14A and 14B are diagrams for describing an operation example of the data analyzing device according to the first embodiment, in which FIG. 14A is a diagram illustrating a case of a related art, and FIG. 14B is a diagram illustrating a case of the data analyzing device according to the first embodiment.

FIG. 15 is a block diagram illustrating a configuration example of a data analyzing device according to a second embodiment.

FIG. 16 is a block diagram illustrating another configuration example of the data analyzing device according to the second embodiment.

FIG. 17 is a block diagram illustrating a configuration example of a data analyzing device according to a third embodiment.

FIGS. 18A and 18B are block diagrams illustrating a hardware configuration example of the data analyzing devices according to the first to third embodiments.

### DESCRIPTION OF EMBODIMENTS

Hereinafter, embodiments will be described in detail with reference to the drawings.

### First Embodiment

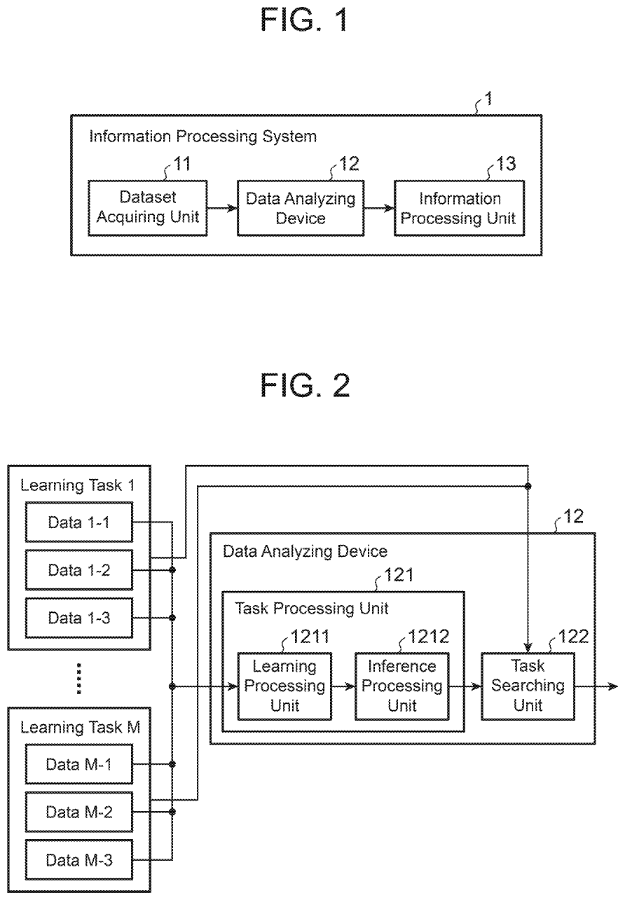

FIG. 1 is a block diagram illustrating a configuration example of an information processing system 1 including a data analyzing device 12 according to a first embodiment.

For example, as illustrated in FIG. 1, the information processing system 1 includes a data set acquiring unit 11, a data analyzing device 12, and an information processing unit 13. Examples of the information processing system 1 include a character image classification system that classifies character images.

The data set acquiring unit 11 acquires a data set. For example, as illustrated in FIG. 2, the data set has a plurality of learning tasks. Further, each of the plurality of learning tasks has a plurality of pieces of data.

The data analyzing device 12 receives an input of the data set acquired by the data set acquiring unit 11 and analyzes data of the data set in units of tasks. A configuration example of the data analyzing device 12 will be described later.

The information processing unit 13 performs information processing in units of tasks on the basis of an analysis result by the data analyzing device 12. For example, in a case where the information processing system 1 is a character image classification system, the information processing unit 13 classifies character images indicated by data input to the information processing system 1 in units of tasks.

Next, a configuration example of the data analyzing device 12 according to the first embodiment will be described with reference to FIG. 2.

For example, as illustrated in FIG. 2, the data analyzing device 12 includes a task processing unit 121 and a task searching unit 122.

For example, as illustrated in FIG. 2, the task processing unit 121 includes a learning processing unit 1211 and an inference processing unit 1212. The task processing unit 121 illustrated in FIG. 2 performs multi-task learning.

The learning processing unit 1211 receives an input of a data set, performs learning processing on the basis of the data set, and outputs data indicating an inference model parameter. Note that, in the example of FIG. 2, the learning processing unit 1211 receives an input of a data set including learning tasks 1 to M. Further, in the example of FIG. 2, the learning task 1 includes data 1-1 to 1-3, and a learning task M includes data M-1 to M-3.

The inference processing unit 1212 receives inputs of data indicating an output result by the learning processing unit 1211 and data indicating an inference task, performs inference processing on the basis of the data indicating the output result and the inference task, and outputs an inference processing result for the inference task or data indicating a performance evaluation value of the inference processing result. The inference task is a test task or a purpose task.

Note that FIG. 2 illustrates a case where the task processing unit 121 performs the learning processing and the inference processing.

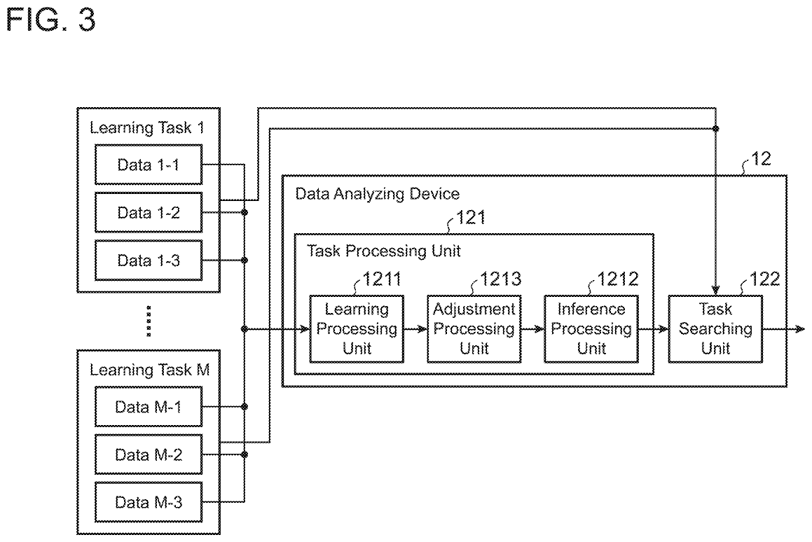

However, it is not limited thereto, and for example, the task processing unit 121 may perform the inference processing after performing additional adjustment processing after performing the learning processing. That is, in this case, for example, as illustrated in FIG. 3, the task processing unit 121 includes an adjustment processing unit 1213 in addition to the learning processing unit 1211 and the inference processing unit 1212. The task processing unit 121 illustrated in FIG. 3 performs multi-task learning or meta-learning.

In this case, the learning processing unit 1211 receives an input of a data set, performs the learning processing on the basis of the data set, and outputs data indicating an inference model parameter or data indicating a meta-parameter. That is, the learning processing unit 1211 outputs data indicating the inference model parameter in a case where the multi-task learning is performed, and outputs data indicating the meta-parameter in a case where the meta-learning is performed.

The adjustment processing unit 1213 receives inputs of data indicating an output result by the learning processing unit 1211 and data indicating an inference task, performs the additional adjustment processing on the basis of the data indicating the output result and the inference task, and outputs data indicating an inference model parameter. Here, in a case where the output result by the learning processing unit 1211 is data indicating the inference model parameter, the adjustment processing unit 1213 adjusts the inference model parameter in the additional adjustment processing, and outputs data indicating the adjusted inference model parameter. Further, in a case where the output result by the learning processing unit 1211 is the meta-parameter, the adjustment processing unit 1213 determines an inference model parameter in the additional adjustment processing, and outputs data indicating the inference model parameter.

Further, the inference processing unit 1212 receives inputs of data indicating an output result by the adjustment processing unit 1213 and data indicating an inference task, performs the inference processing on the basis of the data indicating the output result and the inference task, and outputs an inference processing result for the inference task or data indicating a performance evaluation value of the inference processing result.

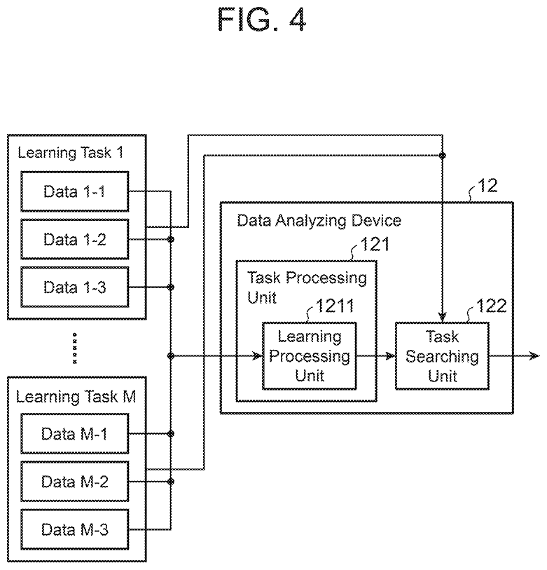

Further, for example, the task processing unit 121 may perform only the learning processing without performing the inference processing. That is, in this case, for example, as illustrated in FIG. 4, the task processing unit 121 includes the learning processing unit 1211. The task processing unit 121 illustrated in FIG. 4 performs multi-task learning or meta-learning.

In this case, the learning processing unit 1211 receives an input of a data set, performs the learning processing on the basis of the data set, and outputs data indicating an inference model parameter or data indicating a meta-parameter. That is, the learning processing unit 1211 outputs data indicating the inference model parameter in a case where the multi-task learning is performed, and outputs data indicating the meta-parameter in a case where the meta-learning is performed.

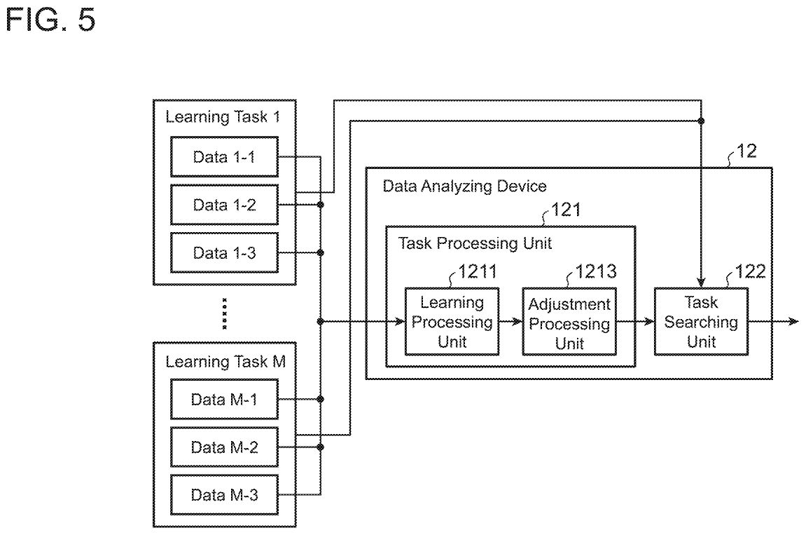

Further, for example, the task processing unit 121 may perform only the learning processing and the additional adjustment processing without performing the inference processing. That is, in this case, for example, as illustrated in FIG. 5, the task processing unit 121 includes the learning processing unit 1211 and the adjustment processing unit 1213. The task processing unit 121 illustrated in FIG. 5 performs multi-task learning or meta-learning.

In this case, the learning processing unit 1211 receives an input of a data set, performs the learning processing on the basis of the data set, and outputs data indicating an inference model parameter or data indicating a meta-parameter. That is, the learning processing unit 1211 outputs data indicating the inference model parameter in a case where the multi-task learning is performed, and outputs data indicating the meta-parameter in a case where the meta-learning is performed.

The task searching unit 122 performs calculation processing of calculating a contribution of the learning task included in the data set to the output result on the basis of the data set and the output result by the task processing unit 121.

Alternatively, the task searching unit 122 performs the above calculation processing and selection processing of selecting a learning task having a characteristic contribution on the basis of the calculation processing result. At this time, in the selection processing, the task searching unit 122 selects at least one of a learning task having a large contribution to the output result or a learning task having a small contribution to the output result.

Data indicating the contribution calculated by the task searching unit 122 or data indicating the learning task (identification information) selected by the task searching unit 122 is output to the outside. Thus, the user can grasp the contribution or the learning task having a characteristic contribution.

Note that the “contribution” means, for example, a variation amount of a calculation processing result in a case where data used for calculation or a processing method thereof is changed on the basis of some rule in calculation processing of an amount such as a performance evaluation value or a prediction value, or an approximate value thereof. Note that the variation amount may be changed to a variation rate in a case where the data is parameterized data.

For example, the variation amount may be a variation amount of a performance index in a case where learning is performed by removing specific data from the data set.

Further, for example, the variation amount may be a variation amount of the performance index in a case where learning is performed by replacing specific data with dummy data in the data set.

Furthermore, for example, the variation amount may be a differential coefficient for a weighting parameter of the performance index in a case where learning is performed on data obtained by taking a weighted average of specific data and the dummy-data values in the data set.

Further, the “contribution for each task” means, for example, a variation amount of the calculation processing result in a case where a change in coordination in some sense is added to the entire data included for each task or the processing method thereof, or an approximate value thereof. Note that the variation amount may be changed to a variation rate in a case where the data is parameterized data.

For example, the variation amount may be a variation amount of a performance index in a case where learning is performed by excluding a specific task from the data set.

Further, for example, the variation amount may be a variation amount of a performance index in a case where learning is performed by replacing a specific task with a dummy task in a data set.

Furthermore, for example, the variation amount may be a differential coefficient for a weighting parameter of the performance index in a case where learning is performed on all data included in the specific task, using values obtained by taking a weighted average, via a common weighting parameter, between the task data and the dummy-data values in the data set.

Note that, in a case where the task processing unit 121 performs a plurality of processes, for example, the task searching unit 122 calculates the contribution between input and output for each of the processes, and calculates the contribution of the learning task to the final output result in the task processing unit 121 by combining the contributions.

For example, in a case where the task processing unit 121 performs the learning processing and inference processing, a case where the task searching unit 122 calculates the contribution of the learning task to the output result by the inference processing unit 1212 will be considered.

In this case, first, the task searching unit 122 calculates the contribution of the learning task to the output result by the learning processing unit 1211. This contribution is defined as a first contribution.

Further, the task searching unit 122 calculates the contribution of the output result by the learning processing unit 1211 to the output result by the inference processing unit 1212. This contribution is defined as a second contribution.

Then, the task searching unit 122 calculates the contribution of the learning task to the output result by the inference processing unit 1212 by combining the first contribution and the second contribution.

Further, for example, in a case where the task processing unit 121 performs the learning processing, the additional adjustment processing, and the inference processing, a case where the task searching unit 122 calculates the contribution of the learning task to the output result by the inference processing unit 1212 will be considered.

In this case, first, the task searching unit 122 calculates the contribution of the learning task to the output result by the learning processing unit 1211. This contribution is defined as a first contribution.

Further, the task searching unit 122 calculates the contribution of the output result by the learning processing unit 1211 to the output result by the adjustment processing unit 1213. This contribution is defined as a third contribution.

Further, the task searching unit 122 calculates the contribution of the output result by the adjustment processing unit 1213 to the output result by the inference processing unit 1212. This contribution is defined as a fourth contribution.

Then, the task searching unit 122 calculates the contribution of the learning task to the output result by the inference processing unit 1212 by combining the first contribution, the third contribution, and the fourth contribution.

Further, for example, a case where the task processing unit 121 performs the learning processing and the adjustment processing, and the task searching unit 122 calculates the contribution of the learning task to the output result by the adjustment processing unit 1213 will be considered.

In this case, first, the task searching unit 122 calculates the contribution of the learning task to the output result by the learning processing unit 1211. This contribution is defined as a first contribution.

Further, the task searching unit 122 calculates the contribution of the output result by the learning processing unit 1211 to the output result by the adjustment processing unit 1213. This contribution is defined as a third contribution.

Then, the task searching unit 122 calculates the contribution of the learning task to the output result by the adjustment processing unit 1213 by combining the first contribution and the third contribution.

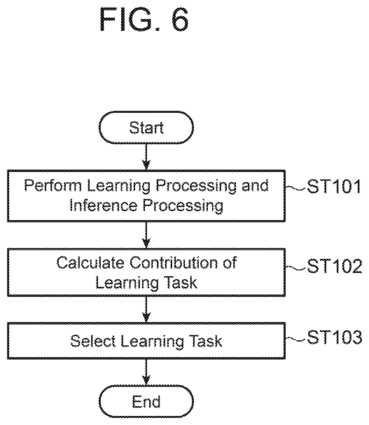

Next, an operation example of the data analyzing device 12 according to the first embodiment will be described with reference to FIG. 6.

Note that, although an operation example in a case where the task processing unit 121 has the configuration illustrated in FIG. 2 will be described below, the same applies to an operation example in a case where the task processing unit 121 has the configuration illustrated in FIGS. 3 to 5. Further, a case where the task searching unit 122 selects a learning task having a characteristic contribution will be described below.

In the operation example of the data analyzing device 12 according to the first embodiment, for example, as illustrated in FIG. 6, the task processing unit 121 performs the learning processing and the inference processing (step ST101). That is, the learning processing unit 1211 receives an input of a data set having a plurality of learning tasks each having a plurality of pieces of data, performs the learning processing on the basis of the data set, and outputs data indicating an inference model parameter. Then, the inference processing unit 1212 receives inputs of data indicating an output result by the learning processing unit 1211 and data indicating an inference task, performs the inference processing on the basis of the data indicating the output result and the inference task, and outputs an inference processing result for the inference task or data indicating a performance evaluation value of the inference processing result.

Next, the task searching unit 122 performs calculation processing of calculating a contribution of the learning task included in the data set to the output result on the basis of the data set and the output result by the task processing unit 121 (step ST102).

At this time, first, the task searching unit 122 calculates the contribution of the learning task to the output result by the learning processing unit 1211. This contribution is defined as a first contribution.

Further, the task searching unit 122 calculates the contribution of the output result by the learning processing unit 1211 to the output result by the inference processing unit 1212. This contribution is defined as a second contribution.

Then, the task searching unit 122 calculates the contribution of the learning task to the output result by the inference processing unit 1212 by combining the first contribution and the second contribution.

Next, the task searching unit 122 performs selection processing of selecting a learning task having a characteristic contribution on the basis of the calculation processing result (step ST103). At this time, in the selection processing, the task searching unit 122 selects at least one of a learning task having a large contribution to the output result or a learning task having a small contribution to the output result.

Data indicating the learning task (identification information) selected by the task searching unit 122 is output to the outside. Thus, the user can grasp the contribution or the learning task having a characteristic contribution.

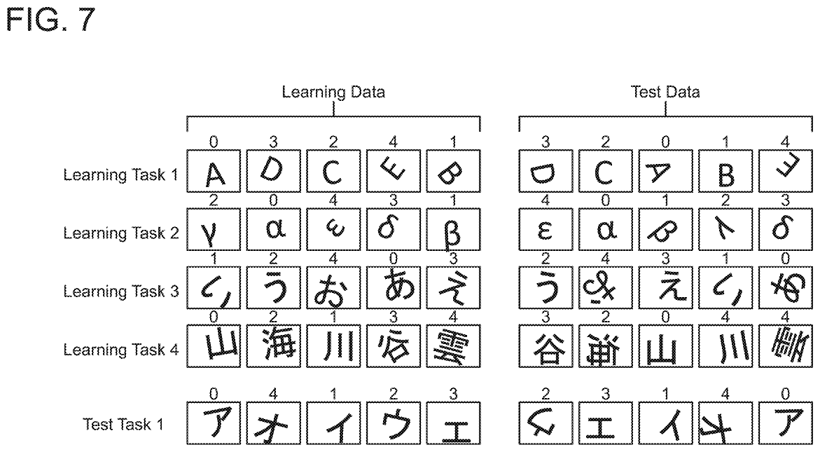

FIG. 7 is a diagram illustrating an example of a data set and an inference task (test task) used in the data analyzing device 12 according to the first embodiment. FIG. 7 illustrates an example of a data set for classifying a plurality of types of character images as the data set.

Note that, in FIG. 7, in a case where the data set is a data set for multi-task learning, the learning task included in the data set includes only learning data on the left side of FIG. 7. Further, in FIG. 7, in a case where the data set is a data set for meta-learning, the learning task included in the data set includes both the learning data on the left side and test data on the right side in FIG. 7. That is, in a case of meta-learning, it is necessary to learn a meta-parameter for enhancing test performance of a learning result of each task, and thus the learning task includes the test data in addition to the learning data.

Further, images are classified for each character type in each learning task.

Furthermore, as illustrated in FIG. 7, in general, a task used for learning is different in type from a target task or a test task.

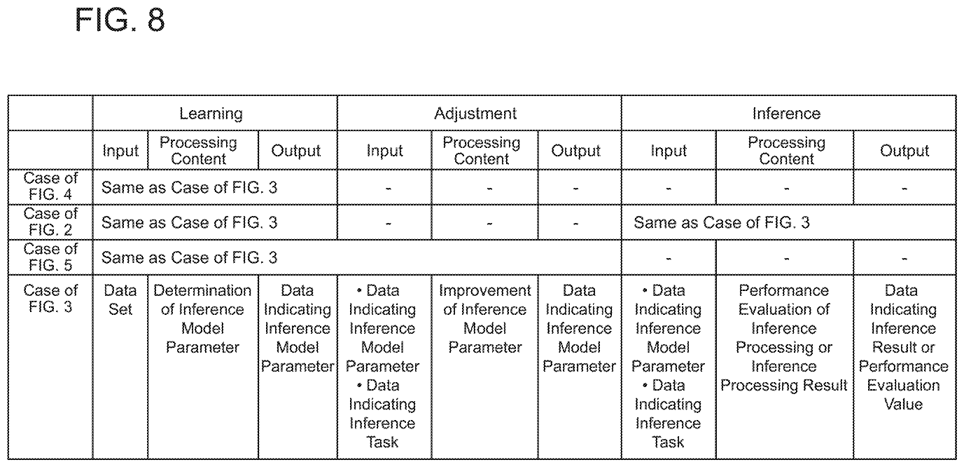

FIG. 8 is a diagram for describing an operation example in a case of multi-task learning of the task processing unit 121 in the first embodiment. Note that the additional adjustment processing is generally referred to as “additional learning” or “fine tuning” in many cases.

The processing flow illustrated in FIG. 8 proceeds from left to right.

In FIG. 8, the first row illustrates a case where the task processing unit 121 performs only the learning processing, for example, as illustrated in FIG. 4.

In this case, the learning processing unit 1211 receives an input of a data set, determines an inference model parameter on the basis of learning data included in the data set, and outputs data indicating the inference model parameter.

The second row illustrates, for example, a case where the task processing unit 121 performs the learning processing and the inference processing as illustrated in FIG. 2.

In this case, the learning processing unit 1211 receives an input of a data set, determines an inference model parameter on the basis of learning data included in the data set, and outputs data indicating the inference model parameter.

Further, the inference processing unit 1212 receives inputs of the data indicating the inference model parameter output by the learning processing unit 1211 and data indicating an inference task, performs performance evaluation of the inference processing or an inference processing result on the basis of the inference model parameter and the inference task, and outputs data indicating a performance evaluation value of the inference processing or the inference processing result.

The third row illustrates, for example, a case where the task processing unit 121 performs the learning processing and the additional adjustment processing as illustrated in FIG. 5.

In this case, the learning processing unit 1211 receives an input of a data set, determines an inference model parameter on the basis of learning data included in the data set, and outputs data indicating the inference model parameter.

Further, the adjustment processing unit 1213 receives inputs of the data indicating the inference model parameter output by the learning processing unit 1211 and data indicating an inference task, improves the inference model parameter on the basis of the inference task, and outputs data indicating the inference model parameter.

The fourth row illustrates, for example, a case where the task processing unit 121 performs the learning processing, the additional adjustment processing, and the inference processing as illustrated in FIG. 3.

In this case, the learning processing unit 1211 receives an input of a data set, determines an inference model parameter on the basis of learning data included in the data set, and outputs data indicating the inference model parameter.

Further, the adjustment processing unit 1213 receives inputs of the data indicating the inference model parameter output by the learning processing unit 1211 and data indicating an inference task, improves the inference model parameter, and outputs data indicating the inference model parameter.

Furthermore, the inference processing unit 1212 receives inputs of the data indicating the inference model parameter output by the adjustment processing unit 1213 and the data indicating the inference task, performs performance evaluation of the inference processing or an inference processing result on the basis of the inference model parameter and the inference task, and outputs data indicating a performance evaluation value of the inference processing or the inference processing result.

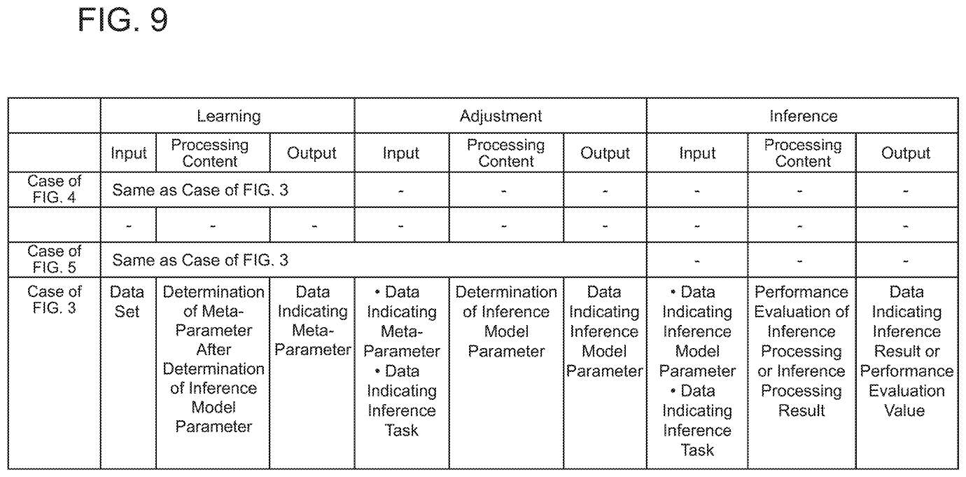

FIG. 9 is a diagram for describing an operation example in a case of meta-learning of the task processing unit 121 in the first embodiment. Note that, in general, the learning processing is often referred to as “meta-learning”, and the additional adjustment processing is often referred to as “adaptation” or “learning”.

The processing flow illustrated in FIG. 9 is from left to right.

Further, in a case of the meta-learning, in a case where the inference processing is performed, the additional adjustment processing is essential in the preceding stage, and thus there is no processing corresponding to the second row in the case of the multi-task learning illustrated in FIG. 8.

In FIG. 8, the first row illustrates a case where the task processing unit 121 performs only the learning processing, for example, as illustrated in FIG. 4.

In this case, the learning processing unit 1211 receives an input of a data set, determines an inference model parameter on the basis of learning data included in the data set, determines a meta-parameter that achieves the best inference performance with test data, and outputs data indicating the meta-parameter.

The third row illustrates, for example, a case where the task processing unit 121 performs the learning processing and the additional adjustment processing as illustrated in FIG. 5.

In this case, the learning processing unit 1211 receives an input of a data set, determines an inference model parameter on the basis of learning data included in the data set, determines a meta-parameter that achieves the best inference performance with test data, and outputs data indicating the meta-parameter.

Further, the adjustment processing unit 1213 receives inputs of the data indicating the meta-parameter output by the learning processing unit 1211 and data indicating an inference task, determines an inference model parameter on the basis of the meta-parameter and the inference task, and outputs data indicating the inference model parameter.

The fourth row illustrates, for example, a case where the task processing unit 121 performs the learning processing, the additional adjustment processing, and the inference processing as illustrated in FIG. 3.

In this case, the learning processing unit 1211 receives an input of a data set, determines an inference model parameter on the basis of learning data included in the data set, determines a meta-parameter that achieves the best inference performance with test data, and outputs data indicating the meta-parameter.

Further, the adjustment processing unit 1213 receives inputs of the data indicating the meta-parameter output by the learning processing unit 1211 and data indicating an inference task, determines an inference model parameter on the basis of the meta-parameter and the inference task, and outputs data indicating the inference model parameter.

Furthermore, the inference processing unit 1212 receives inputs of the data indicating the inference model parameter output by the adjustment processing unit 1213 and the data indicating the inference task, performs performance evaluation of the inference processing or an inference processing result on the basis of the inference model parameter and the inference task, and outputs data indicating a performance evaluation value of the inference processing or the inference processing result.

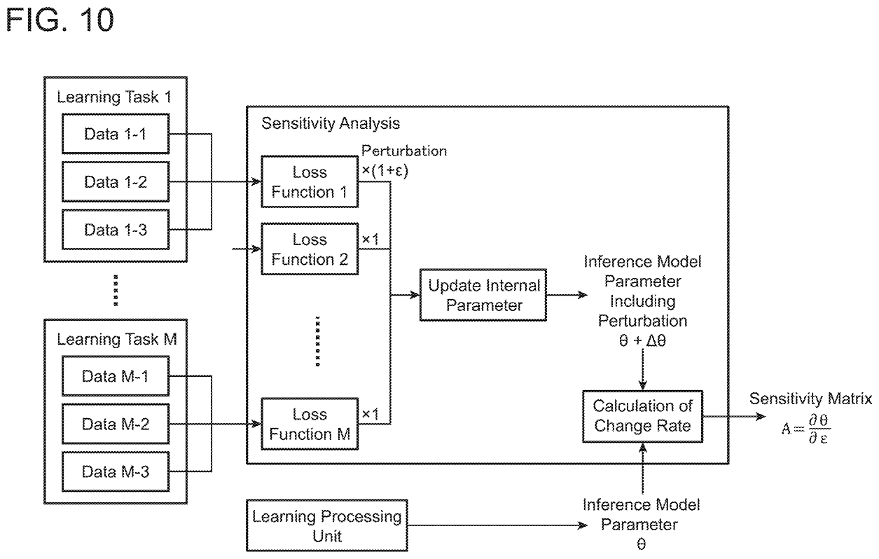

FIG. 10 is a diagram for describing an operation example of calculating a contribution of a learning task to a learning processing result in the task searching unit 122 in the first embodiment.

As illustrated in FIG. 10, for example, when calculating the contribution of the learning task to the learning processing result, the task searching unit 122 calculates a sensitivity matrix A which is a differential coefficient for a perturbation parameter. At this time, the size of the sensitivity matrix A, which is a contribution calculated by the task searching unit 122, is <number of inference model parameters>×<number of learning tasks>.

That is, for example, the task processing unit 121 determines the inference model parameter on the basis of a loss function in the entire data set. The loss function in the entire data set is obtained by combining the loss function for each of learning tasks included in the data set for each of the learning tasks.

Then, in this case, on the basis of a loss function obtained by modifying a loss function of any one learning task with a perturbation parameter common to the entire data in the learning task with respect to the loss function in the entire data set, the task searching unit 122 calculates a differential coefficient for the perturbation parameter and sets the differential coefficient as a contribution of the learning task.

Here, a perturbation of the loss function in a case where a loss function (C) for all data (x) is expressed as in the following Expression (1) using an inference model parameter (θ), a data set (D₁, . . . , D_{M}) having M learning tasks, and a loss function (L) for each learning task is considered.

$$C ( θ , {D}_{1} , … , {D}_{M} ) = {\sum }_{i = 1}^{M} {\sum }_{x ∈ {D}_{i}} L ( x ) \qquad ( 1 )$$

Then, a loss function (C′) in a case where a perturbation by a perturbation parameter (ε) as in the following Expression (2) is given to any one learning task (j) among the learning tasks included in the data set with respect to the Expression (1) is considered.

$${C}^{′} ( θ , {D}_{1} , … , {D}_{M} , ε ) = {\sum }_{i = 1}^{M} {\sum }_{x ∈ {D}_{i}} L ( x ) + ε {\sum }_{x ∈ {D}_{j}} L ( x ) \qquad ( 2 )$$

Here, the value of θ that minimizes C′ depends on ε. Accordingly, the task searching unit 122 sets the value of the differential coefficient at ε=0 as a contribution of the learning task (j) to the learning processing result. Then, the task searching unit 122 calculates a contribution of each learning task by performing the above processing for all the learning tasks included in the data set.

Note that the output of the learning processing is expressed as an implicit function of the perturbation parameter by, for example, a process of minimizing the loss function. Accordingly, a differential coefficient between variables that gives a solution to a minimization problem can be calculated using implicit differentiation as in the related art.

That is, for example, the task processing unit 121 determines a value that achieves an extreme value of the loss function in the entire data set or a model parameter that is an approximate value of the value.

Then, in this case, the task searching unit 122 calculates the contribution of the learning task to the inference model parameter determined by the task processing unit 121 by implicit differentiation.

Here, in the related art, the perturbation of the loss function is considered for each individual piece of data (x) without considering a situation in which data is distinguished by the learning task as in the following Expression (3).

On the other hand, in the data analyzing device 12 according to the first embodiment, the perturbation of the loss function is considered for each learning task (D) as in Expression (2). In other words, in the data analyzing device 12 according to the first embodiment, a plurality of pieces of data is bundled into one learning task, and a coordinated perturbation of the entire data therein is considered.

$$C ( θ , {D}_{1} , … , {D}_{M} , ε ) = ( {\sum }_{i = 1}^{M} {\sum }_{x ∈ {D}_{i}} L ( x ) ) + ε L ( x ) \qquad ( 3 )$$

Note that FIG. 10 illustrates an example in which the task searching unit 122 calculates a differential coefficient by numerical differentiation.

However, it is not limited thereto, and the task searching unit 122 can calculate a strict differential coefficient by using various mathematical facts.

Further, in a case where the task processing unit 121 performs a plurality of processes, for example, the task searching unit 122 calculates a differential coefficient as a contribution between input and output in each of the processes performed by the task processing unit 121 to form a matrix, and calculates a matrix product of matrices for each of the plurality of processes to combine a contribution.

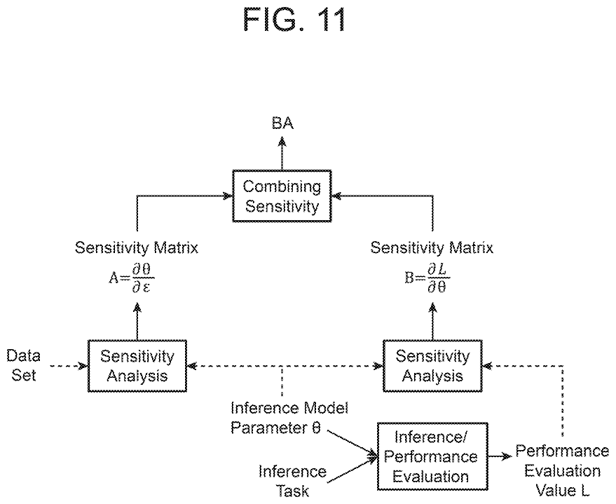

For example, as illustrated in FIG. 11, in a case where the task processing unit 121 performs the learning processing and the inference processing, the task searching unit 122 calculates a sensitivity matrix B, which is a differential coefficient, as a contribution of an output result by the learning processing unit 1211 to an output result by the inference processing unit 1212, in addition to the sensitivity matrix A.

At this time, the size of the sensitivity matrix B, which is the contribution calculated by the task searching unit 122, is <number of performance evaluation values>×<number of inference model parameters>.

Then, for example, as illustrated in FIG. 11, the task searching unit 122 calculates a matrix product (B·A) of the sensitivity matrix A and the sensitivity matrix B, thereby calculating the contribution of each learning task to the output result by the inference processing unit 1212. The contribution is a matrix having a size of <number of performance evaluation values>×<number of learning tasks>.

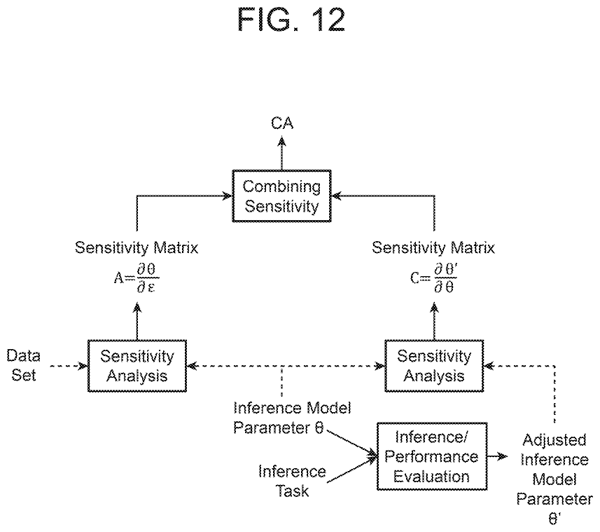

Further, for example, as illustrated in FIG. 12, in a case where the task processing unit 121 performs the learning processing and the additional adjustment processing, the task searching unit 122 calculates a sensitivity matrix C, which is a differential coefficient, as the contribution of the output result by the learning processing unit 1211 to an output result by the adjustment processing unit 1213, in addition to the sensitivity matrix A.

At this time, the size of the sensitivity matrix C, which is the contribution calculated by the task searching unit 122, is <number of inference model parameters>×<number of inference model parameters>.

Then, for example, as illustrated in FIG. 12, the task searching unit 122 calculates the matrix product (C·A) of the sensitivity matrix A and the sensitivity matrix C, thereby calculating the contribution of each learning task to the output result by the adjustment processing unit 1213. The contribution is a matrix having a size of <number of inference model parameters>×<number of learning tasks>.

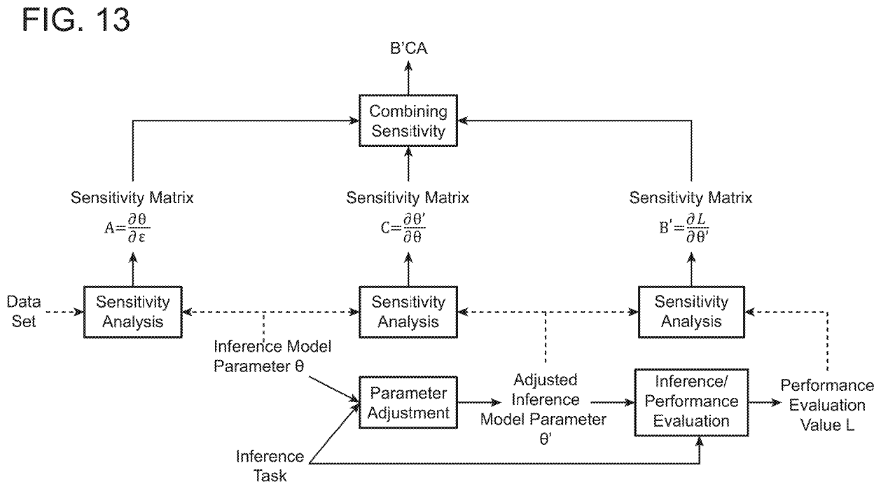

Further, for example, as illustrated in FIG. 13, in a case where the task processing unit 121 performs the learning processing, the additional adjustment processing, and the inference processing, the task searching unit 122 calculates a sensitivity matrix B′ that is a differential coefficient as a contribution of the output result by the adjustment processing unit 1213 to the output result by the inference processing unit 1212, in addition to the sensitivity matrix A and the sensitivity matrix C.

At this time, the sensitivity matrix B′, which is the contribution calculated by the task searching unit 122, has a size of <number of performance evaluation values>×<number of inference model parameters>.

Then, for example, as illustrated in FIG. 13, the task searching unit 122 calculates the matrix product (B′·C·A) of the sensitivity matrix A, the sensitivity matrix C, and the sensitivity matrix B′, thereby calculating the contribution of each learning task to the output result by the inference processing unit 1212. The contribution is a matrix having a size of <number of performance evaluation values>×<number of learning tasks>.

Note that, in FIGS. 11 to 13, the case where the task processing unit 121 performs the multi-task learning has been described as an example, but the same applies to the case where the task processing unit 121 performs the meta-learning.

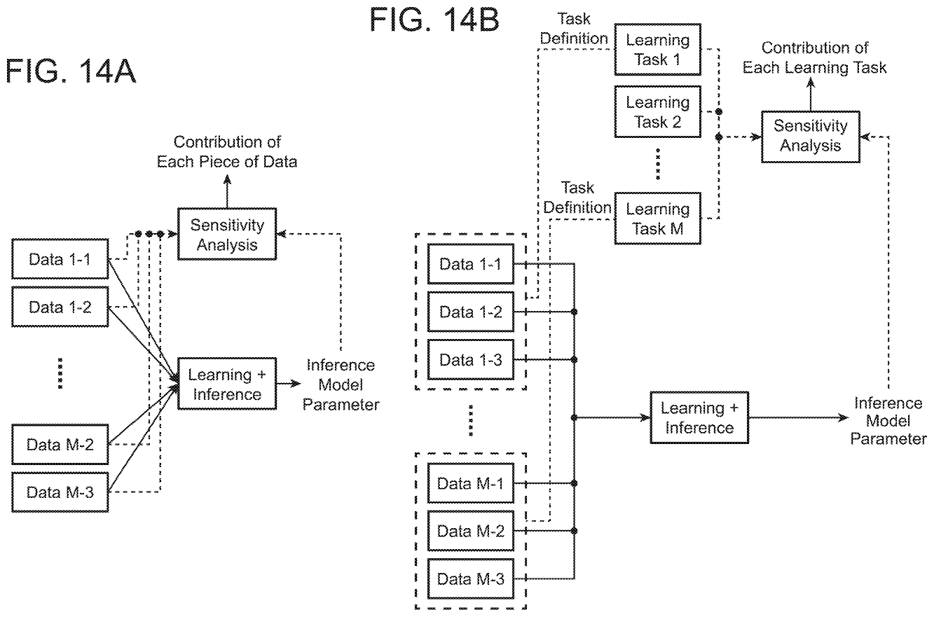

Here, as illustrated in FIG. 14A, in the related art, the contribution is calculated for each piece of data. On the other hand, as illustrated in FIG. 14B, in the data analyzing device 12 according to the first embodiment, the contribution is calculated for each learning task having a plurality of pieces of data.

Thus, in the data analyzing device 12 according to the first embodiment, it is possible to calculate a contribution of a task in which pieces of data are collected on the basis of a certain standard rather than an individual piece of data, it is possible to present a description that is more intuitively easy for the user to understand, and it is possible to determine reliability based on whether a task similar to a task that is desired to be performed by a device is presented as a task having a high contribution.

Note that, in the above description, the case where the information processing system 1 is the character image classification system has been described as an example, but the information processing system 1 to which the data analyzing device 12 is used is not limited thereto.

The information processing system 1 may be, for example, a four-wheel torque control device, a power consumption predicting device, or a production line monitoring system.

The four-wheel torque control device is a device that receives an input of data indicating a sensor value from the outside, recognizes a road surface state from the sensor value in the information processing unit 13, and adjusts torque output of each wheel of the vehicle.

In data analysis in the four-wheel torque control device, a learning task is defined for each road surface state such as a normal road surface, a snowy road, and a gravel road, and the four-wheel torque control device learns efficient torque distribution in each of them.

Then, when switching a control pattern, the four-wheel torque control device displays information of a similar road surface state experienced at the time of learning on the dashboard.

Here, in the related art, only the sensor value used for learning can be displayed. On the other hand, in the four-wheel torque control device to which the data analyzing device 12 according to the first embodiment is used, it is possible to perform display by a character string abstracted like “snowy road” or “gravel road” or an icon in units of tasks.

Further, the power consumption predicting device is used to an operating environment, a production line of an air conditioning system, or the like, receives an input of data indicating a sensor value from the outside, and predicts power consumption in the information processing unit 13.

In data analysis in the power consumption predicting device, a learning task is defined for each condition such as a use environment, a date, and a season, and the power consumption predicting device learns future power consumption from time-series data of a power use state in each condition.

Then, at the start of use of the device, the power consumption predicting device notifies the device whether or not the user has experienced a similar condition at the time of learning.

Here, in the related art, only the sensor value used for learning can be displayed. On the other hand, in the power consumption predicting device to which the data analyzing device 12 according to the first embodiment is used, it is possible to present experience contents based on categories such as seasons or types of used devices in units of tasks.

Further, the production line monitoring system is a system that is used to an environment or the like in which a person and a robot work close to each other, receives an input of data indicating a sensor value from the outside, predicts a behavior pattern of the person in the information processing unit 13, and stops the operation of the robot when there is a risk of contact.

In data analysis in the production line monitoring system, a learning task is defined for each environment of the production line, and the production line monitoring system learns, for each case, an area into which a person may enter and a probability of contact with a robot several seconds in the future from a camera image, Lidar data, or the like.

Then, at the time of introduction of the system, the production line monitoring system notifies the user whether or not the device has experienced data of a similar production environment at the time of learning.

Here, in the related art, only the sensor value used for learning can be displayed. On the other hand, in the production line monitoring system to which the data analyzing device 12 according to the first embodiment is used, it is possible to present experience contents based on categories such as congestion or a type of production line in units of tasks.

Note that, in the above description, the case where the task searching unit 122 calculates the contribution of the learning task to the output result of the final processing in the task processing unit 121 and uses the calculated contribution as output data has been described as an example. However, it is not limited thereto, and the task searching unit 122 may calculate the contribution of the learning task to the output result of the processing in the middle of the task processing unit 121 and use the contribution as the output data.

For example, in a case where the task processing unit 121 performs the learning processing, the additional adjustment processing, and the inference processing, the task searching unit 122 may calculate the contribution of the learning task to the learning processing and use the result as output data, or may calculate the contribution of the learning task to the additional adjustment processing and use the result as output data. Thus, the data analyzing device 12 can confirm the state of the information processing system 1 in more detail.

As described above, according to the first embodiment, the data analyzing device 12 includes the task processing unit 121 including the learning processing unit 1211 to receive an input of a data set including a plurality of learning tasks each including a plurality of pieces of data and output data indicating an inference model parameter or metadata, and the task searching unit 122 to receive inputs of the data set and data indicating an output result by the task processing unit 121, and output data indicating a contribution of a learning task included in the data set to the output result or data indicating a learning task of which the contribution is characteristic.

Thus, the data analyzing device 12 according to the first embodiment can analyze data in units of tasks. That is, in the data analyzing device 12 according to the first embodiment, it is possible to more appropriately evaluate the reliability by presenting explanatory information in units of tasks.

In addition, according to the first embodiment, the learning processing unit 1211 outputs data indicating an inference model parameter, and the task processing unit 121 includes the inference processing unit 1212 to receive inputs of data indicating an output result by the learning processing unit 1211 and data indicating an inference task, and output an inference processing result for the inference task or data indicating a performance evaluation value of the inference processing result.

Further, according to the first embodiment, the task processing unit 121 includes the adjustment processing unit 1213 to receive inputs of data indicating an output result by the learning processing unit 1211 and data indicating an inference task, and output data indicating an inference model parameter.

Furthermore, according to the first embodiment, the task processing unit 121 includes the adjustment processing unit 1213 to receive inputs of data indicating an output result by the learning processing unit 1211 and data indicating an inference task, and output data indicating an inference model parameter, and the inference processing unit 1212 to receive inputs of data indicating an output result by the adjustment processing unit 1213 and data indicating an inference task, and output an inference processing result for the inference task or data indicating a performance evaluation value of the inference processing result.

Thus, the data analyzing device 12 according to the first embodiment can analyze data in units of tasks.

In addition, according to the first embodiment, the task searching unit 122 calculates a first contribution that is a contribution of a learning task included in the data set to an output result by the learning processing unit 1211 and a second contribution that is a contribution of an output result by the learning processing unit 1211 to an output result by the inference processing unit 1212, and calculates a contribution of the learning task to the output result by the inference processing unit 1212 by combining the first contribution and the second contribution.

Further, according to the first embodiment, the task searching unit 122 calculates the first contribution that is a contribution of a learning task included in the data set to an output result by the learning processing unit 1211 and a third contribution that is a contribution of an output result by the learning processing unit 1211 to an output result by the adjustment processing unit 1213, and calculates a contribution of the learning task to the output result by the adjustment processing unit 1213 by combining the first contribution and the third contribution.

Furthermore, according to the first embodiment, the task searching unit 122 calculates the first contribution that is a contribution of a learning task included in the data set to an output result by the learning processing unit 1211, the third contribution that is a contribution of an output result by the learning processing unit 1211 to an output result by the adjustment processing unit 1213, and a fourth contribution that is a contribution of the output result by the adjustment processing unit 1213 to an output result by the inference processing unit 1212, and calculates a contribution of the learning task to the output result by the inference processing unit 1212 by combining the first contribution, the third contribution, and the fourth contribution.

Thus, the data analyzing device 12 according to the first embodiment can analyze data in units of tasks.

In addition, according to the first embodiment, the task processing unit 121 determines an inference model parameter on the basis of a loss function in the entire data set obtained by combining a loss function of each of learning tasks included in the data set for each of the learning tasks, and the task searching unit 122 calculates a differential coefficient for a perturbation parameter on the basis of a loss function obtained by deforming a loss function of any one learning task with the perturbation parameter common to entire data in the learning task with respect to the loss function in the entire data set, and sets the differential coefficient as a contribution of the learning task.

Further, according to the first embodiment, the task searching unit 122 calculates a differential coefficient as a contribution between input and output in each of processes performed by the task processing unit 121 to form a matrix, and calculates a matrix product of matrices for each of the plurality of processes to combine a contribution.

Furthermore, according to the first embodiment, the task processing unit 121 determines a value that achieves an extreme value of a loss function in the entire data set or a model parameter that is an approximate value of the value, and the task searching unit 122 calculates a contribution of the learning task to the inference model parameter determined by the task processing unit 121 by implicit differentiation.

Thus, the data analyzing device 12 according to the first embodiment can analyze data in units of tasks.

Further, according to the first embodiment, the information processing system 1 includes the data set acquiring unit 11 to acquire a data set including a plurality of learning tasks each including a plurality of pieces of data, the data analyzing device 12, and the information processing unit 13 to perform information processing in units of tasks on the basis of an output result by the data analyzing device 12, in which the data analyzing device 12 receives an input of the data set acquired by the data set acquiring unit 11.

Thus, the information processing system 1 according to the first embodiment can perform information processing in units of tasks.

Furthermore, according to the first embodiment, a data analyzing method includes the steps of: receiving, by the task processing unit 121, an input of a data set including a plurality of learning tasks each including a plurality of pieces of data, and outputting data indicating an inference model parameter or metadata; and receiving, by the task searching unit 122, inputs of the data set and data indicating an output result by the task processing unit 121, and outputting data indicating a contribution of a learning task included in the data set to the output result or data indicating a learning task of which the contribution is characteristic.

Thus, the data analyzing method according to the first embodiment can analyze data in units of tasks.

### Second Embodiment

In a data analyzing device 12 according to a second embodiment, a case where a data set is processed on the basis of a learning task having a characteristic contribution will be described.

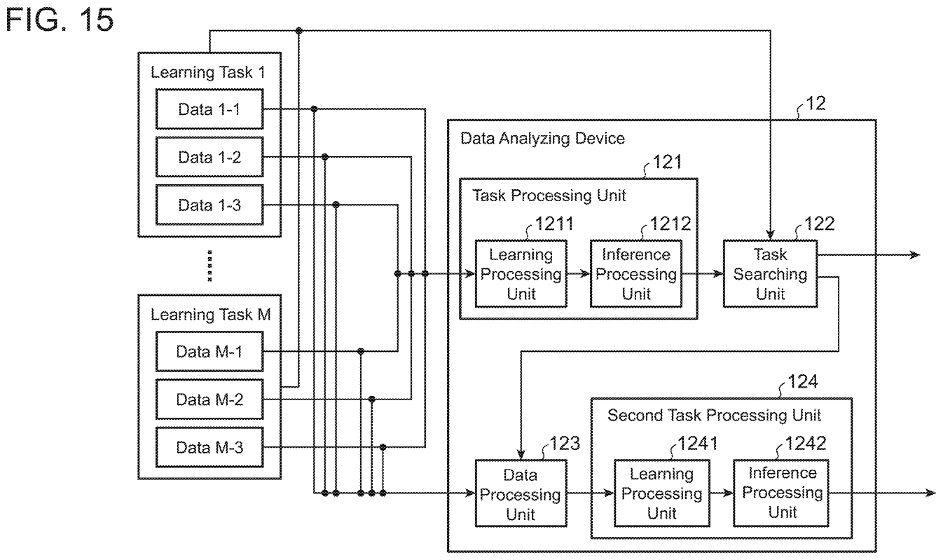

FIG. 15 is a diagram illustrating a configuration example of a data analyzing device 12 according to the second embodiment. In the data analyzing device 12 according to the second embodiment illustrated in FIG. 15, a data processing unit 123 and a second task processing unit 124 are added to the data analyzing device 12 according to the first embodiment illustrated in FIG. 2. Other configuration examples of the data analyzing device 12 according to the second embodiment illustrated in FIG. 15 are similar to the configuration examples of the data analyzing device 12 according to the first embodiment, and will be described with the same reference numerals.

Note that the task searching unit 122 outputs data indicating a learning task having a characteristic contribution to the data processing unit 123.

The data processing unit 123 processes data included in a data set on the basis of an output result by the task searching unit 122.

At this time, for example, the data processing unit 123 may exclude a learning task having a low contribution (for example, near 0) to a learning processing result from among learning tasks included in the data set. That is, since it is considered that such a learning task does not affect the inference performance, the learning task is excluded from the data set in order to reduce calculation cost of calculation of explanatory information.

Further, for example, the data processing unit 123 may add a copy of a learning task having a large contribution to an inference processing result or a performance evaluation value on the positive side among the learning tasks included in the data set. That is, since such a learning task is considered to improve inference performance, a copy of the same learning task is added to the data set.

Further, for example, the data processing unit 123 may exclude a learning task having a large contribution to an inference processing result or a performance evaluation value on the negative side from among the learning tasks included in the data set. That is, since such a learning task is considered to deteriorate inference performance, it is excluded from the data set.

For example, as illustrated in FIG. 15, the second task processing unit 124 includes a learning processing unit 1241 and an inference processing unit 1242 that performs inference processing. The second task processing unit 124 illustrated in FIG. 15 performs multi-task learning.

The learning processing unit 1241 receives an input of a data set processed by the data processing unit 123, performs learning processing on the basis of the data set, and outputs data indicating an inference model parameter.

The inference processing unit 1242 receives inputs of data indicating an output result by the learning processing unit 1241 and data indicating an inference task, performs inference processing on the basis of the data indicating the output result and the inference task, and outputs an inference processing result for the inference task or data indicating a performance evaluation value of the inference processing result.

That is, the function of the second task processing unit 124 is the same as the function of the task processing unit 121.

Further, FIG. 15 illustrates a case where the task processing unit 121 and the second task processing unit 124 perform the learning processing and the inference processing.

However, it is not limited thereto, and as in FIGS. 3 to 5, the task processing unit 121 and the second task processing unit 124 may perform the learning processing, additional adjustment processing, and the inference processing, may perform only the learning processing, or may perform the learning processing and the additional adjustment processing. In this case, the second task processing unit 124 performs multi-task learning or meta-learning.

Note that, in the above description, a case where the task searching unit 122, the data processing unit 123, and the second task processing unit 124 each perform processing once is illustrated.

However, it is not limited thereto, and a configuration may be employed in which the output result by the second task processing unit 124 is input to the task searching unit 122 again, a loop may be formed among the task searching unit 122, the data processing unit 123, and the second task processing unit 124, and each of the task searching unit 122, the data processing unit 123, and the second task processing unit 124 performs processing a plurality of times.

Further, the data analyzing device 12 according to the second embodiment may present data indicating a selection result in the middle of the learning task in the task searching unit 122 to the user and request the user to determine whether or not to perform data processing and reprocessing.

Note that, in the data analyzing device 12 according to the second embodiment, the case where the data processing unit 123 processes the data included in the data set and then performs reprocessing using the processed data set has been described.

However, it is not limited thereto. The data analyzing device 12 can be served as a data cleansing device by outputting an improved data set, which is an output of the data processing unit 123, to the outside. That is, in this case, the second task processing unit 124 is unnecessary.

Note that, as utilization of the data analyzing device 12 according to the second embodiment, for example, the following is conceivable.

For example, it may not be possible to assume in advance what kind of learning task has a learning effect. Accordingly, a utilization method is conceivable in which a redundant learning task is included in a first data set input to the data analyzing device 12, and the data set is processed in such a manner that the data processing unit 123 narrows down to data having a learning effect depending on an output result by the task searching unit 122.

Further, for example, in the case of the classification problem, for a specific learning task included in the first data set, a new learning task obtained by subtracting the number of classes or the number of pieces of data for each class in the learning task may be created and added to the data set, and the data set after the addition may be input to the data analyzing device 12.

Furthermore, for example, in addition to the learning task using a raw sensor value, a new learning task including data subjected to filter processing may be created and added to the first data set, and the data set after the addition may be input to the data analyzing device 12.

Further, FIG. 15 illustrates a case where the data analyzing device 12 is provided with the second task processing unit 124 separately from the task processing unit 121.

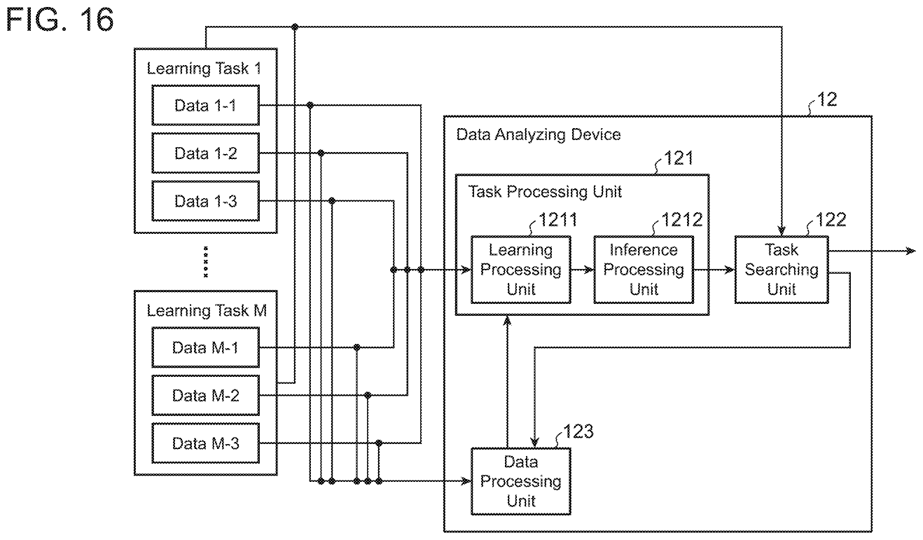

However, it is not limited thereto, and for example, as illustrated in FIG. 16, a configuration may be employed in which the second task processing unit 124 is not provided, and the task processing unit 121 includes the function of the second task processing unit 124.

That is, in this case, the learning processing unit 1211 included in the task processing unit 121 receives an input of the data set processed by the data processing unit 123 and performs the processing again.

As described above, according to the second embodiment, the task searching unit 122 outputs data indicating a learning task having a characteristic contribution, and the data processing unit 123 to process data included in the data set on the basis of an output result by the task searching unit 122 is provided.

Further, according to the second embodiment, the data analyzing device 12 includes the second task processing unit 124 including the learning processing unit 1241 to receive an input of a data set processed by the data processing unit 123 and output data indicating an inference model parameter or metadata.

Furthermore, according to the second embodiment, the learning processing unit 1211 included in the task processing unit 121 receives an input of a data set processed by the data processing unit 123 and performs processing again.

Thus, the data analyzing device 12 according to the second embodiment can further improve reliability with respect to the data analyzing device 12 according to the first embodiment. That is, in the data analyzing device 12 according to the second embodiment, since data is handled in units of learning tasks, it is possible to improve the efficiency of data reconstruction work. In addition, even in a case where it is not possible to assume which learning task has a learning effect, it is also possible to use a method of performing first task processing using a data set having a redundant configuration and then narrowing down the task to a necessary learning task.

### Third Embodiment

In a data analyzing device 12 according to a third embodiment, a case where attribute information is attached to a learning task and attribute information attached to a learning task having a characteristic contribution is extracted will be described.

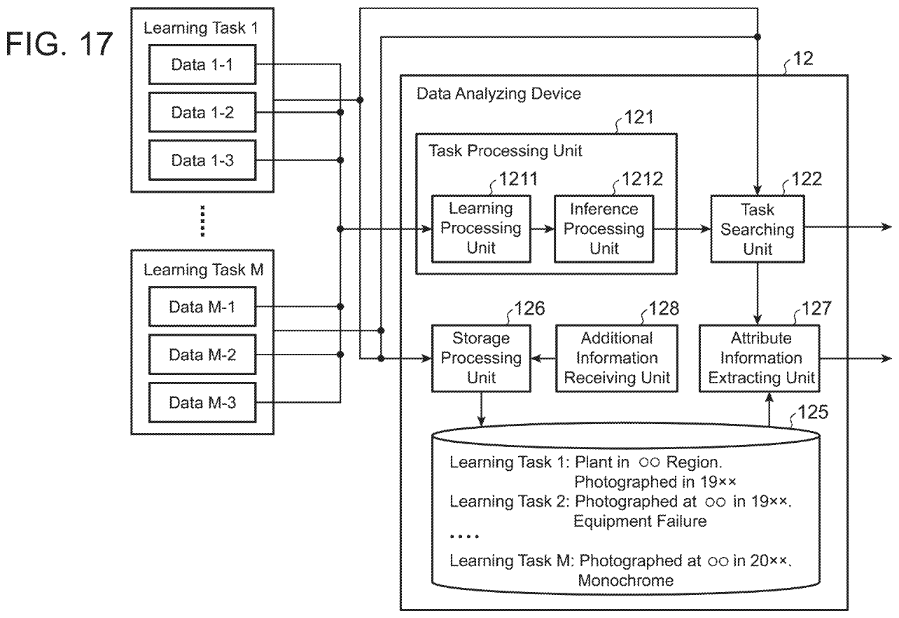

FIG. 17 is a diagram illustrating a configuration example of the data analyzing device 12 according to the third embodiment. In the data analyzing device 12 according to the third embodiment illustrated in FIG. 17, a storage unit 125, a storage processing unit 126, an attribute information extracting unit 127, and an additional information receiving unit 128 are added to the data analyzing device 12 according to the first embodiment illustrated in FIG. 2. Other configuration examples of the data analyzing device 12 according to the third embodiment illustrated in FIG. 17 are the same as the configuration examples of the data analyzing device 12 according to the first embodiment, and will be described with the same reference numerals.

Note that attribute information indicating an attribute of the learning task is attached to a data set input to the data analyzing device 12 for each learning task. Examples of the attribute information attached to the learning task include a description of the learning task, an acquisition date and time of data included in the learning task, acquisition conditions of the data, and the like.

Further, the task searching unit 122 outputs data indicating the learning task having a characteristic contribution to the attribute information extracting unit 127.

The storage unit 125 stores the attribute information attached to the learning task together with the information indicating the learning task depending on the processing by the storage processing unit 126.

Examples of this storage unit 125 include a nonvolatile or volatile semiconductor memory such as a random access memory (RAM), a read only memory (ROM), a flash memory, an erasable programmable ROM (EPROM), or an electrically EPROM (EEPROM), a magnetic disk, a flexible disk, an optical disk, a compact disk, a mini disk, a digital versatile disc (DVD), or the like.

Further, FIG. 17 illustrates a case where the storage unit 125 is provided inside the data analyzing device 12. However, it is not limited thereto, and the storage unit 125 may be provided outside the data analyzing device 12.

The storage processing unit 126 stores information indicating a learning task included in the data set and attribute information attached to the learning task in the storage unit 125 in association with each other on the basis of the data set.

The storage unit 125 illustrated in FIG. 17 stores information indicating a description of a learning task 1 and the acquisition date and time of data included in the learning task 1, such as “Plant in ◯◯ region. Photographed in 19XX”, as the attribute information for the learning task 1. Further, the storage unit 125 illustrated in FIG. 17 stores information indicating the acquisition date and time and acquisition conditions of data included in a learning task 2, such as “Photographed at ◯◯ in 19XX. Equipment failure”, as the attribute information for the learning task 2. Furthermore, the storage unit 125 illustrated in FIG. 17 stores information indicating the acquisition date and time and acquisition conditions of the data included in the learning task M, such as “Photographed at ◯◯ in 20XX. Monochrome”, as the attribute information for the learning task M.

The attribute information extracting unit 127 extracts the attribute information associated with the learning task from the storage unit 125 on the basis of the learning task indicated by the data output by the task searching unit 122. Data indicating the attribute information extracted by the attribute information extracting unit 127 is output to the outside.

Thus, since the data analyzing device 12 can output the attribute information attached to the learning task to the outside together with the data indicating the learning task output by the task searching unit 122, more detailed information can be presented to the user.

The additional information receiving unit 128 receives information indicating a learning task that is an addition target and additional information for attribute information attached to the learning task, which are input by the user. Examples of the additional information include a comment left when the user uses the data analyzing device 12.

Then, on the basis of the information received by the additional information receiving unit 128, the storage processing unit 126 adds additional information to the attribute information attached to the learning task that is an addition target and stores the additional information in the storage unit 125.

Note that FIG. 17 illustrates a case where the additional information receiving unit 128 is provided in the data analyzing device 12. However, the additional information receiving unit 128 is not an essential component of the data analyzing device 12, and the additional information receiving unit 128 need not be provided in the data analyzing device 12.

Further, FIG. 17 illustrates a case where the storage unit 125, the storage processing unit 126, the attribute information extracting unit 127, and the additional information receiving unit 128 are added to the data analyzing device 12 according to the first embodiment.

However, it is not limited thereto, and the storage unit 125, the storage processing unit 126, the attribute information extracting unit 127, and the additional information receiving unit 128 may be added to the data analyzing device 12 according to the second embodiment, and effects similar to those described above can be obtained.

As described above, according to the third embodiment, attribute information indicating an attribute of the learning task is attached to the data set for each of learning tasks, and the task searching unit 122 outputs data indicating a learning task having a characteristic contribution, and there are included the storage processing unit 126 to cause information indicating a learning task included in the data set and attribute information attached to the learning task to be stored in the storage unit 125 in association with each other on the basis of the data set, and the attribute information extracting unit 127 to extract attribute information associated with the learning task from the storage unit 125 on the basis of the learning task indicated by the data output by the task searching unit 122.

Thus, the data analyzing device 12 according to the third embodiment can present more detailed information to the user.

In addition, according to the third embodiment, the data analyzing device 12 includes the additional information receiving unit 128 to receive information indicating a learning task that is an addition target and additional information with respect to attribute information attached to the learning task, which are input by the user, in which the storage processing unit 126 causes the storage unit 125 to store additional information by adding the additional information to the attribute information attached to the learning task that is the addition target on the basis of the information received by the additional information receiving unit 128.

Thus, the data analyzing device 12 according to the third embodiment can add the information input by the user as the attribute information.

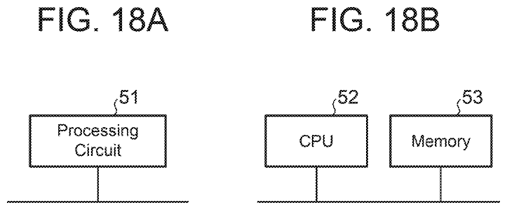

Finally, a hardware configuration example of the data analyzing device 12 according to the first to third embodiments will be described with reference to FIG. 18. Here, a hardware configuration example of the data analyzing device 12 according to the first embodiment will be described, but the same applies to the hardware configuration examples of the data analyzing device 12 according to the second and third embodiments.

Functions of the task processing unit 121 and the task searching unit 122 in the data analyzing device 12 are each implemented by a processing circuit 51. The processing circuit 51 may be dedicated hardware as illustrated in FIG. 18A, or may be a central processing unit (CPU, which may also be referred to as a central processing device, a processing device, an arithmetic device, a microprocessor, a microcomputer, a processor, or a digital signal processor (DSP)) 52 that executes a program stored in a memory 53 as illustrated in FIG. 18B.

In a case where the processing circuit 51 is dedicated hardware, the processing circuit 51 corresponds to, for example, a single circuit, a composite circuit, a programmed processor, a parallel programmed processor, an application specific integrated circuit (ASIC), a field-programmable gate array (FPGA), or a combination thereof. The function of each of the task processing unit 121 and the task searching unit 122 may be implemented by the processing circuit 51, or the functions of the units may be collectively implemented by the processing circuit 51.

In a case where the processing circuit 51 is the CPU 52, the functions of the task processing unit 121 and the task searching unit 122 are implemented by software, firmware, or a combination of software and firmware. The software and the firmware are described as programs and stored in the memory 53. The processing circuit 51 implements the function of each unit by reading and executing the program stored in the memory 53. That is, the data analyzing device 12 includes a memory for storing a program that results in execution of each step illustrated in FIG. 4, for example, when executed by the processing circuit 51. Further, it can also be said that these programs cause a computer to execute the procedures and methods performed by the task processing unit 121 and the task searching unit 122. Here, the memory 53 corresponds to, for example, a nonvolatile or volatile semiconductor memory such as RAM, ROM, a flash memory, EPROM, or EEPROM, a magnetic disk, a flexible disk, an optical disk, a compact disk, a mini disk, or DVD.

Note that some of the functions of the task processing unit 121 and the task searching unit 122 may be implemented by dedicated hardware, and some may be implemented by software or firmware. For example, the function of the task processing unit 121 can be implemented by the processing circuit 51 as dedicated hardware, and the function of the task searching unit 122 can be implemented by the processing circuit 51 reading and executing a program stored in the memory 53.

As described above, the processing circuit 51 can implement the above-described functions by hardware, software, firmware, or a combination thereof.

Note that free combinations of the individual embodiments, modifications of any components of the individual embodiments, or omissions of any components in the individual embodiments are possible.

### INDUSTRIAL APPLICABILITY

The data analyzing device 12 according to the present disclosure can analyze data in units of tasks, and is suitable for use in the data analyzing device 12 or the like that analyzes data.

### REFERENCE SIGNS LIST

1: information processing system, 11: data set acquiring unit, 12: data analyzing device, 13: information processing unit, 51: processing circuit, 52: CPU, 53: memory, 121: task processing unit, 122: task searching unit, 123: data processing unit, 124: second task processing unit, 125: storage unit, 126: storage processing unit, 127: attribute information extracting unit, 128: additional information receiving unit, 1211: learning processing unit, 1212: inference processing unit, 1213: adjustment processing unit, 1241: learning processing unit, 1242: inference processing unit

1. A data analyzing device comprising:
a task processor includes a learning processor to receive an input of a data set including a plurality of learning tasks each including a plurality of pieces of data and output data indicating an inference model parameter or metadata; and
a task searching processor to receive inputs of the data set and data indicating an output result by the task processor, and output data indicating a contribution of a learning task included in the data set to the output result or data indicating a learning task of which the contribution is characteristic.

2. The data analyzing device according to claim 1, wherein
the learning processor outputs data indicating an inference model parameter, and
the task processor includes
an inference processor to receive inputs of data indicating the output result by the learning processor and data indicating an inference task, and output an inference processing result for the inference task or data indicating a performance evaluation value of the inference processing result.

3. The data analyzing device according to claim 1, wherein
the task processor includes
an adjustment processor to receive inputs of data indicating the output result by the learning processor and data indicating an inference task, and output data indicating the inference model parameter.

4. The data analyzing device according to claim 1, wherein
the task processor includes:
an adjustment processor to receive inputs of data indicating the output result by the learning processor and data indicating an inference task, and output data indicating an inference model parameter; and
an inference processor to receive inputs of data indicating the output result by the adjustment processor and data indicating an inference task, and output an inference processing result for the inference task or data indicating a performance evaluation value of the inference processing result.

5. The data analyzing device according to claim 2, wherein
the task searching processor calculates a first contribution that is a contribution of a learning task included in the data set to an output result by the learning processor and a second contribution that is a contribution of an output result by the learning processor to an output result by the inference processor, and calculates a contribution of the learning task to the output result by the inference processor by combining the first contribution and the second contribution.

6. The data analyzing device according to claim 3, wherein
the task searching processor calculates a first contribution that is a contribution of a learning task included in the data set to an output result by the learning processor and a third contribution that is a contribution of an output result by the learning processor to an output result by the adjustment processor, and calculates a contribution of the learning task to the output result by the adjustment processor by combining the first contribution and the third contribution.

7. The data analyzing device according to claim 4, wherein
the task searching processor calculates a first contribution that is a contribution of a learning task included in the data set to an output result by the learning processor, a third contribution that is a contribution of an output result by the learning processor to an output result by the adjustment processor, and a fourth contribution that is a contribution of the output result by the adjustment processor to an output result by the inference processor, and calculates a contribution of the learning task to the output result by the inference processor by combining the first contribution, the third contribution, and the fourth contribution.

8. The data analyzing device according to claim 1, wherein
the task processor determines an inference model parameter on a basis of a loss function in the entire data set obtained by combining a loss function of each of learning tasks included in the data set for each of the learning tasks, and
the task searching processor calculates a differential coefficient for a perturbation parameter on a basis of a loss function obtained by deforming a loss function of any one learning task with the perturbation parameter common to entire data in the learning task with respect to the loss function in the entire data set, and sets the differential coefficient as a contribution of the learning task.

9. The data analyzing device according to claim 5, wherein
the task processor determines an inference model parameter on a basis of a loss function in the entire data set obtained by combining a loss function of each of learning tasks included in the data set for each of the learning tasks, and
the task searching processor calculates a differential coefficient for a perturbation parameter on a basis of a loss function obtained by deforming a loss function of any one learning task with the perturbation parameter common to entire data in the learning task with respect to the loss function in the entire data set, and sets the differential coefficient as a contribution of the learning task.

10. The data analyzing device according to claim 9, wherein
the task searching processor calculates a differential coefficient as a contribution between input and output in each of a plurality of processes performed by the task processor to form a matrix, and calculates a matrix product of matrices for each of processes to combine a contribution.

11. The data analyzing device according to claim 8, wherein
the task processor determines a value that achieves an extreme value of a loss function in the entire data set or a model parameter that is an approximate value of the value, and
the task searching processor calculates a contribution of the learning task to the inference model parameter determined by the task processor by implicit differentiation.

12. The data analyzing device according to claim 9, wherein
the task processor determines a value that achieves an extreme value of a loss function in the entire data set or a model parameter that is an approximate value of the value, and
the task searching processor calculates a contribution of the learning task to the inference model parameter determined by the task processor by implicit differentiation.

13. The data analyzing device according to claim 1, wherein
the task searching processor outputs data indicating a learning task having a characteristic contribution, and
the data analyzing device comprises a data processor to process data included in the data set on a basis of an output result by the task searching processor.

14. The data analyzing device according to claim 13, further comprising:
a second task processor including a learning processor to receive an input of a data set processed by the data processor and output data indicating an inference model parameter or metadata.

15. The data analyzing device according to claim 13, wherein
the learning processor included in the task processor receives an input of a data set processed by the data processor and performs processing again.

16. The data analyzing device according to claim 1, wherein
attribute information indicating an attribute of the learning task is attached to the data set for each of learning tasks,
the task searching processor outputs data indicating a learning task having a characteristic contribution, and
the data analyzing device comprises:
a storage processor to cause information indicating a learning task included in the data set and attribute information attached to the learning task to be stored in a storage in association with each other on a basis of the data set; and
an attribute information extractor to extract the attribute information associated with the learning task from the storage on a basis of the learning task indicated by the data output by the task searching processor.

17. The data analyzing device according to claim 16, comprising:
a receiver configured to receive information indicating a learning task that is an addition target and additional information with respect to attribute information attached to the learning task, which are input by a user, wherein
the storage processor causes the storage to store the additional information with the addition of the attribute information attached to the learning task that is the addition target on a basis of the information received by the receiver.

18. An information processing system comprising:
a data set acquirer to acquire a data set including a plurality of learning tasks each including a plurality of pieces of data;
the data analyzing device according to claim 1; and
an information processor to perform information processing in units of tasks on a basis of an output result by the data analyzing device, wherein
the data analyzing device receives an input of the data set acquired by the data set acquirer.

19. A data analyzing method comprising:
receiving an input of a data set including a plurality of learning tasks each including a plurality of pieces of data, and outputting data indicating an inference model parameter or metadata; and
receiving inputs of the data set and data indicating an output result, and outputting data indicating a contribution of a learning task included in the data set to the output result or data indicating a learning task of which the contribution is characteristic.
